(19) United States
(12) Patent Application Publication
(10) Pub. No.: US 2025/0023037 A1
(43) Pub. Date: Jan. 16, 2025

(54) COBALT FREE LiMn 2-x-y-zNiXFeYAlZO4 SPINEL AS CATHODE MATERIAL FOR Li-ION BATTERIES

(71) Applicant: COUNCIL OF SCIENTIFIC & INDUSTRIAL RESEARCH, New Delhi (IN)

(72) Inventors: Nayaka GIRISH PRAVEEN, Maharashtra, Pune (IN); Shivamurthy BOGALERA PAPAIAH, Maharashtra, Pune (IN)

(21) Appl. No.: 18/712,818

(22) PCT Filed: Oct. 26, 2022
(86) PCT No.: PCT/IN2022/050948

§ 371 Date: May 23, 2024

(30) Foreign Application Priority Data
Nov. 26, 2021 (IN) 202111055044

(51) Int. Cl. H01M 4/505; H01M 4/02; H01M 4/583; H01M 10/0525

(52) U.S. Cl. CPC H01M 4/505; H01M 4/583; H01M 10/0525; H01M 2004/027; H01M 2004/028

(57) ABSTRACT

The present invention relates to a cobalt-free electrode material of formula: LiMn_{2-x-y-z}NiₓFe_{y}Al_{z}O₄ spinel as a cathode material for Li-ion batteries, wherein x=0.8-0.5 y=0.1-0.25 and z=0.1-0.25. The present invention also relates to a Li-ion batteries comprising of said cobalt free spinel as cathode materials.

### FIELD OF THE INVENTION

The present invention relates to a cobalt-free LiMn_{2-x-y-z}NiₓFe_{y}Al_{z}O₄ spinel as a cathode material for Li-ion batteries, wherein x=0.8-0.5, y=0.1-0.25, and z=0.1-0.25. More particularly, the present invention relates to a cobalt-free spinel cathode system comprising doped LiMn₂O₄, wherein the dopants are Ni:Fe:Al in the ratio of 0.8-0.5:0.1-0.25:0.1-0.25.

### BACKGROUND AND PRIOR ART OF THE INVENTION

The Lithium Manganese oxide battery features several advantages that attract consumers. It has long-term reliability, having a life span of 10 years. Because of that, it's widely used in electricity, gas and water meters, fire and smoke alarms, security devices, and so on. Also, due to energy density and time stability in terms of charge and discharge cycles of lithium-ion batteries they are well adapted to portable electronic equipment. Generally, a lithium-ion battery comprises the following two materials (1) a positive electrode (cathode) comprising a lithium-based material (cathode material) and (2) a negative electrode (anode), generally made up of carbon, for example, of graphite (anode material).

The cathode materials routinely used in the Li-ion are an oxide or phosphate-based materials. Cathode materials are the main component of Li-ion batteries since they determine the energy density of a cell through cell voltage and/or capacity. Li-ion batteries are typically based on intercalation/de-intercalation compounds, where lithium ions provided by the cathode are inserted into the host lattice (anode) during charge and extracted during discharge, with a minimal structural change in the host material.

The ideal choice of cathode material depends on various factors, including redox reaction, cell voltage, capacity, energy and power capabilities, cycle life, and temperature of operation.

LiMn₂O₄ is the potential cathode material for Li-ion batteries, but it seriously suffers from capacity fading due to the dissolution of Mn in the electrolyte and disproportionation reaction.

Therefore, there is a need in the art to develop a cathode material resolving this capacity fading issue which occurs due to the dissolution of Mn.

### OBJECTIVES OF THE INVENTION

The main objective of the present invention is to provide a cobalt free spinel cathode system comprising doped LiMn₂O₄, wherein the dopant is Ni:Fe:Al in the ratio of 0.8-0.5:0.1-0.25:0.1-0.25.

Another objective of the present invention is to provide a stable energy storage device comprising of LiMn_{2-x-y-z}NiₓFe_{y}Al_{z}O₄ spinel as a cathode material for Li-ion batteries, wherein x=0.8-0.5 y=0.1-0.25 z=0.1-0.25.

### SUMMARY OF THE INVENTION

Accordingly, to accomplish the objectives, the present invention provides a cobalt free spinel cathode system comprising doped LiMn₂O₄, wherein the dopant is Ni:Fe:Al in the ratio of 0.5:0.1:0.1 or 0.8:0.25:0.25.

In an embodiment, the present invention provides a spinel cathode system comprising doped LiMn₂O₄, wherein the dopant is selected from the Ni, Fe and Al metals. The cathode system thus obtained is completely cobalt free.

In an aspect, the present invention relates to an electrode material, comprising an electrode material of formula

LiMn_{2-x-y-z}NiₓFe_{y}Al_{z}O₄

wherein:
x is 0.8-0.5;
y is 0.1-0.25; and
z is 0.1-0.25.

In another aspect of the present invention, the electrode material is cathode material.

In yet another aspect of the present invention, the electrode material is cobalt free material.

In another aspect of the present invention, the x+y+z of the cathode material is 1.

In another aspect of the present invention, the x is 0.8 or 0.7.

In another aspect of the present invention, the y is 0.1 or 0.2.

In another aspect of the present invention, the z is 0.1 or 0.2.

In another aspect, the present invention provides an electrode material of formula:

LiMn_{2-x-y-z}NiₓFe_{y}Al_{z}O₄

wherein:
x is 0.7;
y is 0.1; and
z is 0.2.

In another aspect of the present invention, the capacity retention of the material is 92% after 500 cycles at 1C rate.

In an embodiment, ratio of the dopant Ni:Fe:Al is in the range of 0.8-0.5:0.1-0.25:0.1-0.25 and the cathode system is synthesized in aqueous media.

In another embodiment of the present invention, the cathode material is LiMnNi_{0.8}Fe_{0.1}Al_{0.1}O₄ (MNFA811), LiMnNi_{0.7}Fe_{0.1}Al_{0.2}O₄ (MNFA712), LiMnNi_{0.7}Fe_{0.2}Al_{0.1}O₄ (MNFA721), LiMnNi_{0.6}Fe_{0.2}Al_{0.2}O₄ (MNFA622) or LiMnNi_{0.5}Fe_{0.25}Al_{0.25}O₄ (MNFA52525).

Another embodiment of the present invention provides an energy storage device comprising of LiMn_{2-x-y-z}NiₓFe_{y}Al_{z}O₄ spinel as a cathode material for Li-ion batteries, wherein x=0.8-0.5 y=0.1-0.25 z=0.1-0.25.

In an embodiment, the cathode material in the energy storage device exhibits outstanding cycling stability with capacity retention of 83.9% after 400 cycles and in a range of 79.5%-88.9% after 1000 cycles at 1C rate.

The cathode material in energy storage device provides a specific capacity of 120.0 mAhg⁻¹ with almost 99.3% coulombic efficiency after 400 cycles, and with 99.2% to 99.5% coulombic efficiencies after 1000 cycles at 1C rates.

The cathode material in the energy storage device is with operating voltage up to 4.8 V. In an embodiment, the present invention provides a lithium ion battery comprising the cathode material as disclosed herein.

### BRIEF DESCRIPTION OF THE DRAWINGS

FIG. 1 illustrates (a) XRD pattern of cathode materials of the present invention, and (b-f). Rietveld refinement results of cathode materials, MNFA811, MNFA712, MNFA721, MNFA622 and, MNFA52525.

FIG. 2 illustrates Raman spectra of cathode materials of the present invention, MNFA811, MNFA712, MNFA721, MNFA622 and, MNFA52525.

FIG. 3 illustrates XPS surveys of (a) MNFA811, (b) MNFA712, (c) MNFA721, (d) MNFA622 and, (e) MNFA52525. High resolution XPS of (a₁-e₁) Mn2p and (a₂-e₂) Ni2p (a₃-e₃)Al2p and (a₄-e₄) Fe2p for all samples.

FIG. 4 illustrates (a) FE-SEM image (b) HR-TEM image, (c) SAED pattern (d) STEM-HAADF image and EDS elemental mapping of ((e) Mn, (f) Ni, (g) Fe, (h) Al and, (i) O) of MNFA811.

FIG. 5 illustrates (a) FE-SEM image (b) HR-TEM image, (c) SAED pattern (d) STEM-HAADF image and EDS elemental mapping of ((e) Mn, (f) Ni, (g) Fe, (h) Al and, (i) O) of MNFA721.

FIG. 6 illustrates (a) FE-SEM image (b) HR-TEM image, (c) SAED pattern (d) STEM-HAADF image and EDS elemental mapping of ((e) Mn, (f) Ni, (g) Fe, (h) Al and, (i) O) of MNFA622.

FIG. 7 illustrates (a) FE-SEM image (b) HR-TEM image, (c) SAED pattern (d) STEM-HAADF image and EDS elemental mapping of ((e) Mn, (f) Ni, (g) Fe, (h) Al and, (i) O) of MNFA52525.

FIG. 8 shows Cyclic voltammograms of MNFA811, MNFA712, MNFA721, MNFA622 and, MNFA52525 at scan rate of 0.1 mVs⁻¹.

FIG. 9 shows Nyquist plots of, MNFA811, MNFA712, MNFA721, MNFA622 and, MNFA5252.

FIG. 10 illustrates (a) Rate capability (b) Cycleability (c) Specific capacity (mAhg⁻¹) v/s Potential (V) plot of MNFA712 at 0.1C-5C (d) Specific capacity (mAhg⁻¹) v/s Potential (V) plot of MNFA712 at 1C for 1000 continues cycles.

FIG. 11 shows general schematic of the lithium ion battery containing the electrode material disclosed herein.

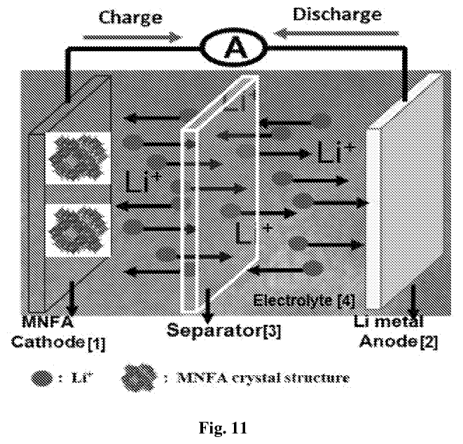

### DETAILED DESCRIPTION OF THE INVENTION

It is to be understood that the figures and descriptions of the present invention have been simplified to illustrate elements that are relevant for a clear understanding of the invention. The detailed description will be provided herein below with reference to the attached drawing.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art.

The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The present invention provides a cobalt free spinel cathode system comprising doped LiMn₂O₄, wherein the dopants are Ni:Fe:Al in the ratio of 0.8-0.5:0.1-0.25:0.1-0.25.

In an embodiment, the present invention provides a spinel cathode system comprising doped LiMn₂O₄, wherein the dopants are Ni, Fe and Al. The cathode system thus obtained is completely cobalt free.

In an embodiment, the present invention relates to a cathode material of formula

LiMn_{2-x-y-z}NiₓFe_{y}Al_{z}O₄

wherein:
x is 0.8-0.5;
y is 0.1-0.25; and
z is 0.1-0.25.

In another embodiment of the present invention, the cathode material is cobalt free material.

In another embodiment of the present invention, the x+y+z of the cathode material is 1.

In another embodiment of the present invention, the x can be 0.8, 0.7, 0.6 or 0.5. Preferably, x can be 0.8 or 0.7.

In another embodiment of the present invention, the y can be 0.1, 0.2 or 0.25. Preferably, y can be 0.1 or 0.2.

In another embodiment of the present invention, the z can be 0.1, 0.2 or 0.25. Preferably, z can be 0.1 or 0.2.

In another embodiment of the present invention, the cathode material is LiMnNi_{0.8}Fe_{0.1}Al_{0.1}O₄, LiMnNi_{0.7}Fe_{0.1}Al_{0.2}O₄, LiMnNi_{0.7}Fe_{0.2}Al_{0.1}O₄, LiMnNi_{0.6}Fe_{0.2}Al_{0.2}O₄ or LiMnNi_{0.5}Fe_{0.25}Al_{0.25}O₄.

In another embodiment, the present invention provides a cathode material of formula:

LiMn_{2-x-y-z}NiₓFe_{y}Al_{z}O₄

wherein:
x is 0.7;
y is 0.1; and
z is 0.2.

In another embodiment, the present invention provides a lithium ion battery comprising the cathode material of LiMnNi_{0.8}Fe_{0.1}Al_{0.1}O₄, LiMnNi_{0.7}Fe_{0.1}Al_{0.2}O₄, LiMnNi_{0.7}Fe_{0.2}Al_{0.1}O₄, LiMnNi_{0.6}Fe_{0.2}Al_{0.2}O₄ or LiMnNi_{0.5}Fe_{0.25}Al_{0.25}O₄.

In another embodiment, the present invention provides a lithium ion battery comprising said cathode material (1), separator (2) and Li metal anode (3). The Li ion battery may recite additional components which a person skilled in the art known from conventional batteries.

In an embodiment of the present invention, ratio of the dopant Ni:Mn:Al is in the range of 0.8-0.5:0.1-0.25:0.1-0.25 and the cathode system is synthesized in aqueous media.

In another embodiment of the present invention, the cobalt free material comprises doped LiMn₂O₄, wherein the dopants are Ni:Fe:Al in the ratio of 0.8-0.5:0.1-0.25:0.1-0.25.

In specific embodiment, the ratio of dopants Ni:Fe:Al in said material is 0.7:0.1:0.2.

Another embodiment of the present invention provides an energy storage device comprising of LiMn_{2-x-y-z}NiₓFe_{y}Al_{z}O₄ spinel as a cathode material for Li-ion batteries, wherein x=0.8-0.5, y=0.1-0.25, z=0.1-0.25.

In another embodiment of the present invention, the cathode material in the energy storage device exhibits outstanding cycling stability with capacity retention of 83.9% after 400 cycles for MNFA811, 79.5%, 82.8%, 88.9%, and 80.5% after 1000 cycles for MNFA712, MNFA721, MNFA622, MNFA52525 respectively at 1C rate.

In another embodiment of the present invention, the cathode material in energy storage device provides a specific capacity of 120.0 mAhg⁻¹ with almost 99.3% coulombic efficiency for MNFA811 after 400 cycles, 99.2%, 99.3%, 99.5%, and 99.4% coulombic efficiencies for MNFA712, MNFA721, MNFA622, MNFA52525 respectively after 1000 cycles at 1C rate.

In yet another embodiment of the present invention, the cathode material in the energy storage device is with operating voltage of 4.8 V.

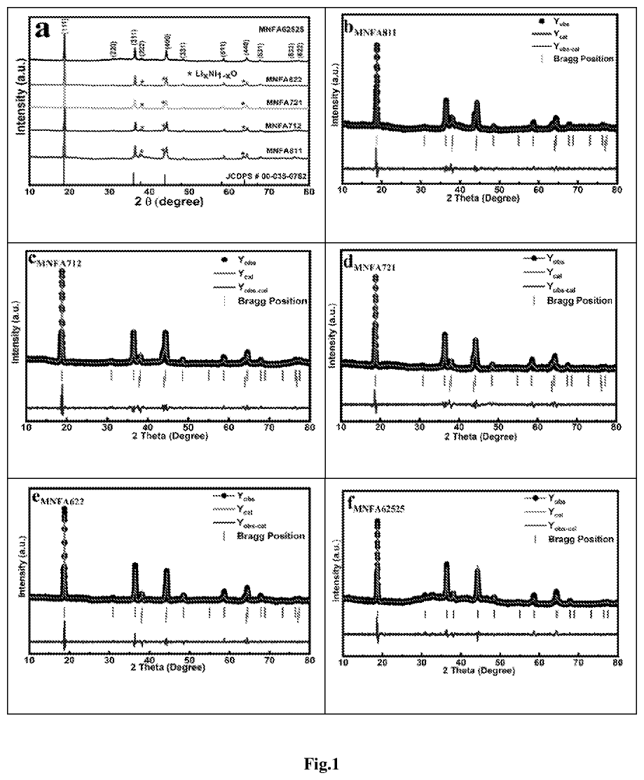

FIG. 1. shows the XRD pattern of the LiMn_{2-x-y-z}NiₓFe_{y}Al_{z}O₄ (wherein x=0.8, y=0.1 and z=0.1) powder, obtained peaks were well matched with standard JCPDS No. 00-018-0782. The obtained diffraction pattern unfolds that the material synthesized is of cubic spinel phase with space group Fd3̅m. The pattern also showed the presence of minor peaks related to the secondary phase in the material with space group Fm3̅m (JCPDS No. 01-075-0543). The refinement studies FIG. 1(b-e) confirmed that the materials synthesized are of mixed-phase, cubic spinel, and cubic rocksalt structures.

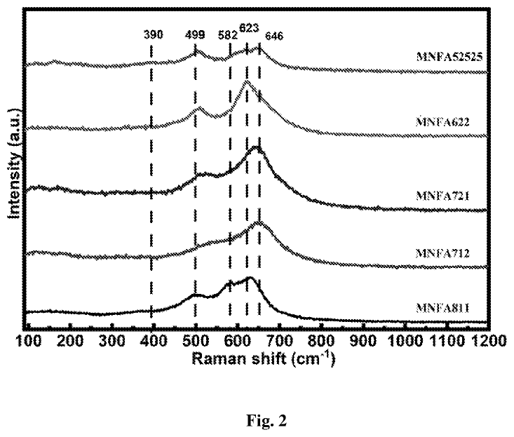

FIG. 2 shows the Raman spectra of LiMn_{2-x-y-z}NiₓFe_{y}Al_{z}O₄ (wherein x=0.8-0.5 y=0.1-0.25 z=0.1-0.25). The obtained peak positions confirm the metal ions are well located in their respective sites.

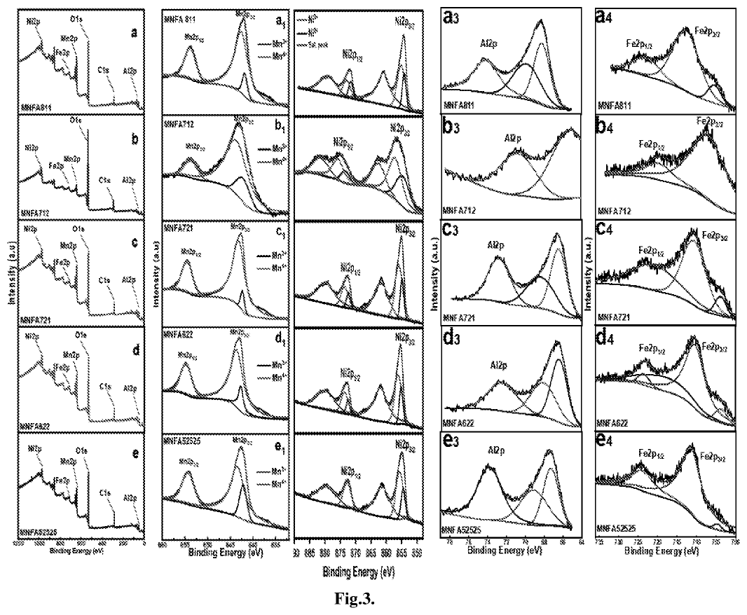

FIG. 3a-e shows the XPS survey and expected elemental composition of MNFA811, MNFA712, MNFA721, MNFA622 and, MNFA52525. The core elements XPS were performed for all the materials to understand the elemental composition and valence states. The deconvoluted spectra of Mn2p consist of Mn2p_{1/2} and Mn2p_{3/2} core levels are shown in FIG. 3 (a₁-e₁). The deconvoluted peak Mn2p_{3/2} core, shows Mn⁴⁺ and Mn³⁺ state with binding energies 642.66 eV, 643.89 eV, 643.17 eV, 643.6 eV, 646.44 eV and 641.89 eV, 642.56 eV, 642.29 eV, 642.58 eV, 642.14 eV respectively, for MNFA811, MNFA712, MNFA721, MNFA622, MNFA52525. The deconvoluted peak Mn2p_{1/2} core shows only the Mn⁴⁺ state for all the materials in the series with binding energies 653.98 eV, 654.78 eV, 654.56 eV, 654.71 eV, and 654.45 eV for MNFA811, MNFA712, MNFA721, MNFA622 and MNFA52525 respectively.

The deconvoluted spectra of Ni2p consist of Ni2p_{3/2} and Ni2p_{1/2} core levels situated at around 854-855 eV and 871-872 eV respectively for all the materials shown in FIG. 3 (a₂-e₂). The deconvoluted peak Ni2p_{3/2} core, shows Ni²⁺ and Ni³⁺ state with binding energies 854.12 eV, 854.8 eV, 854.68 eV, 855.13 eV, 854.45 eV and 855.13 eV, 855.92 eV, 855.83 eV, 856.04 eV, 855.59 eV respectively for MNFA811, MNFA712, MNFA721, MNFA622, MNFA52525.

Deconvoluted spectra of the other substituent elements Al and Fe are also given in FIG. 3. (a₃-e₃) and FIG. 3. (a₄-e₄). The binding energies of Fe and Al confirm that all the substituents were properly doped to the Mn³⁺ site.

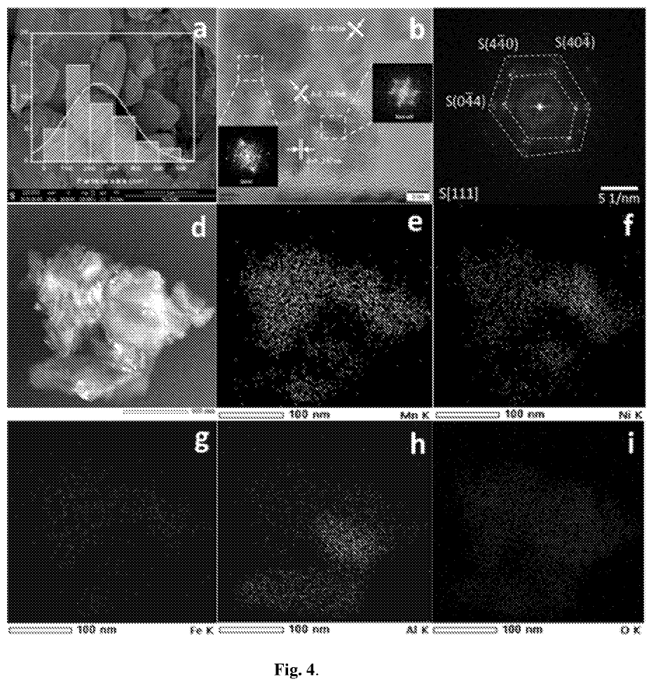

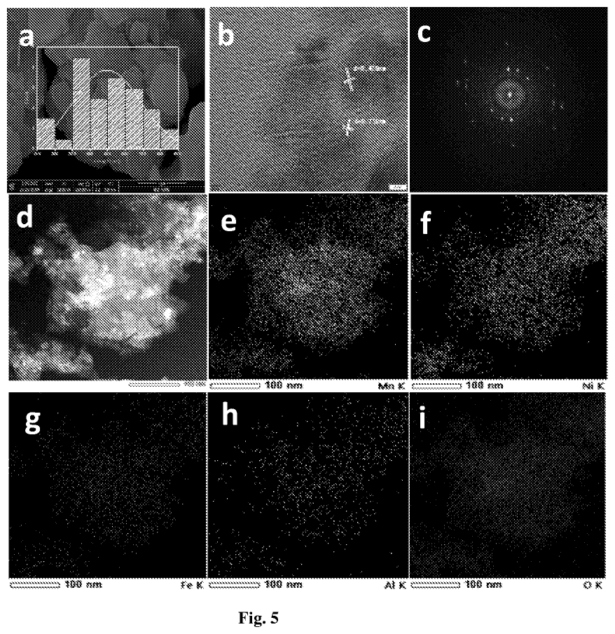

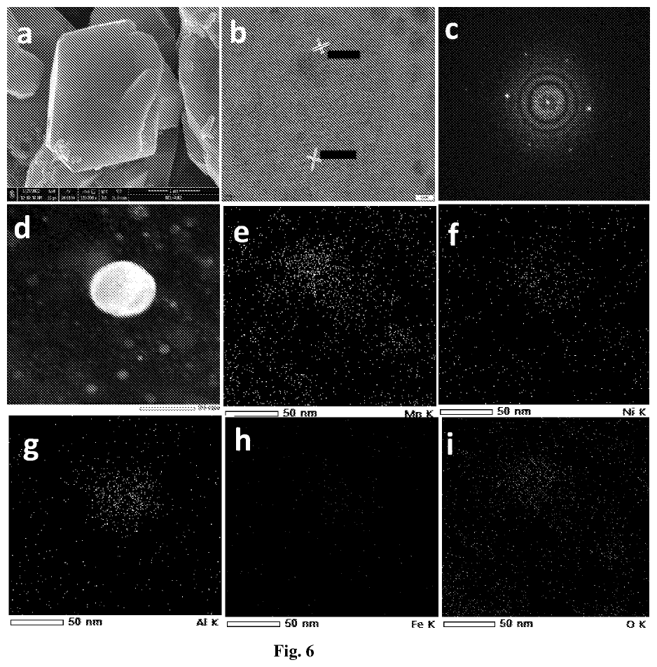

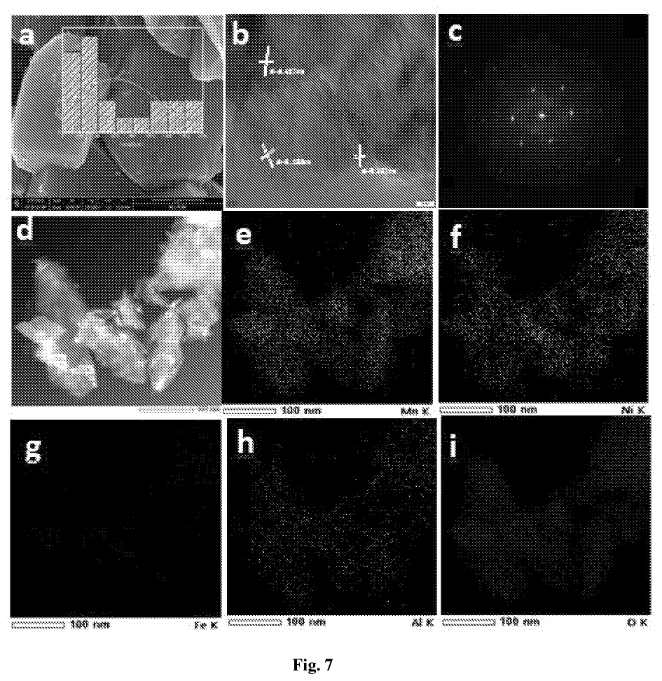

FIG. 4, FIG. 5, FIG. 6, and FIG. 7 shows (a) FE-SEM image (b) HR-TEM image, (c) SAED pattern (d) STEM-HAADF image and EDS elemental mapping of ((e) Mn, (f) Ni, (g) Fe, (h) Al and, (i) O) of MNFA811, MNFA712, MNFA721, MNFA622 and, MNFA52525 respectively. The particles obtained are agglomerated with good crystallinity and polydispersed nature.

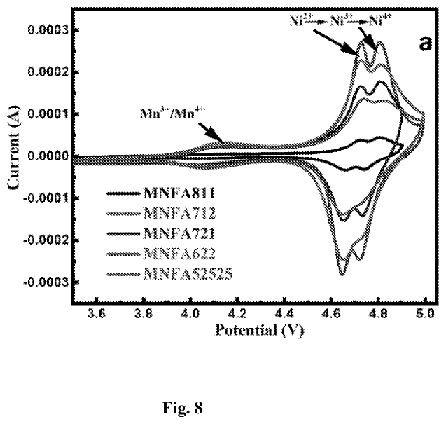

FIG. 8, shows cyclic voltammograms of fabricated 2032 coin cells with MNFA811, MNFA712, MNFA721, MNFA622, and MNFA52525 as cathode materials at room temperature with a scan rate of 0·1 mV s⁻¹. As shown in FIG. 8, three pairs of redox peaks are observed at ˜4.08/4.03 V, ˜4.72/4.63 V, and ˜4.81/4.73 V, indicating three-step intercalation/de-intercalation of Li⁺ during oxidation/reduction reaction. The first weak redox peak observed at 4.08/4.03 V corresponded to Mn⁴⁺/Mn³⁺ redox couple. This feeble peak is due to most Mn being in Mn⁴⁺ state, indicating the minimized content of Mn³⁺ in the material, which minimizes the John-Teller distortion. The second and third high intense redox peaks observed at 4.72/4.63 V and 4.81/4.73 V respectively corresponded to Ni²⁺/Ni⁴⁺, which indicates the predominant electrochemical activity of Ni in the active material.

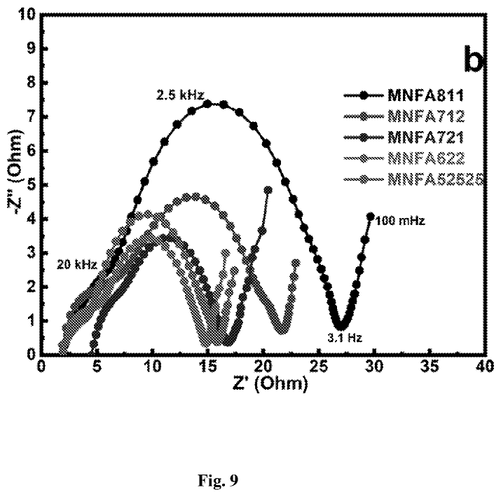

FIG. 9, shows the Nyquist plots of MNFA811, MNFA712, MNFA721, MNFA622, and MNFA52525. In FIG. 9, a semi-circle in the high-frequency region and a straight line in the low-frequency region is seen. A semi-circle in the high-frequency region indicates the insertion of Li ions into the electrode/electrolyte interface, and a straight line in the low-frequency region indicates the interface resistance.

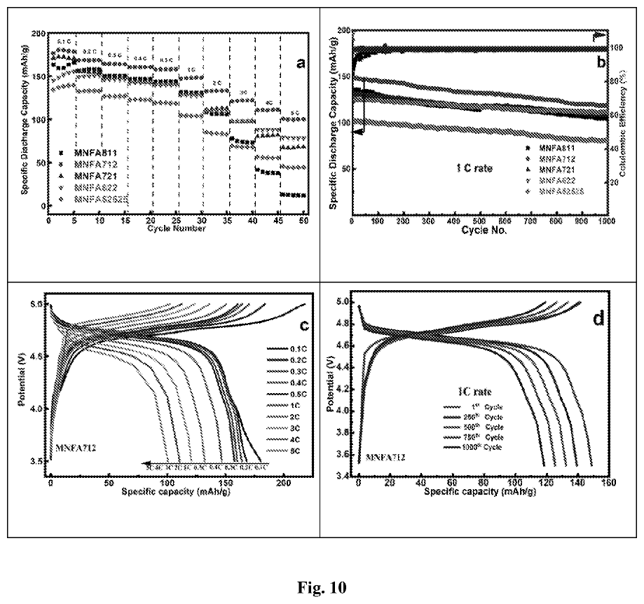

FIG. 10a, shows the rate capability of all materials at different current densities from 0.1 C to 5 C with a voltage window of 3.5 V to 5.0 V. As shown in FIG. 10a, the specific discharge capacities of all the materials shows a gradual decrease as applied current density increases. Here, the reduced rate performance of all the materials at higher current rates might be due to the reformation of layer on the surface of electrode and phase transition of active material over cycling, which hinders the free movement of Li⁺ ions. As well as, if the Ni content reduces or increases by 0.7 mole % in the material, the specific capacity reduces, indicating that Ni ratio plays a vital role in capacity. Along with Ni, Fe content also plays a crucial role in the electrochemical performance of our materials. As the content of Fe increases, the capacity decreases.

The galvanostatic charge/discharge studies were performed between 3.5 to 5V at a constant current density of 1C over 1000 cycles, as shown in FIG. 10b. It can be seen that the initial discharge capacities are 142.9 mAhg⁻¹ (MNFA811), 148.7 mAhg⁻¹ (MNFA712), 131.2 mAhg⁻¹ (MNFA721), 126.4 mAhg⁻¹ (MNFA622), 101.2 mAhg⁻¹ (MNFA62525) while at the end of 1000 cycles the discharge capacities were decreased to for 120.0 mAhg⁻¹ (400 cycles, MNFA811) 118.3 mAhg⁻¹ (MNFA712), 108.7 mAhg⁻¹ (MNFA721), 112.4 mAhg⁻¹ (MNFA622), 81.5 mAhg⁻¹ (MNFA62525) with almost 100% coulombic efficiency. All the materials showed an extraordinary capacity retention of 83.9% (after 400 cycles, MNFA811), 79.5% (MNFA712), 82.8% (MNFA721), 88.9% (MNFA622), and 80.5% (MNFA52525) after 1000 cycles at 1C rate. All the materials of the present invention showed higher and better electrochemical performance with great stability.

FIG. 10c shows the specific capacity v/s Voltage curves of MNFA712 cycled at different current densities, illustrating capacity degradation at higher current. In FIG. 10d, the capacity retention of MNFA712 is exhibited by Specific capacity v/s Voltage curves of different galvanostatic charge-discharge cycles of different intervals at 1C rate. Initially, it showed 148.7 mAhg⁻¹ with coulombic efficiency 99.2% at 1C rate, while at the end of 1000 continuous galvanostatic charge-discharge cycles, the specific capacity has decreased to 118.3 mAg⁻¹ with coulombic efficiency of 99.2%, which implies the capacity retention of MNFA712 is 79.5%. This behavior of MNFA712, which is well supported by various characterizations, can strongly imply that this material can be used for 5V applications in Li-ion batteries.

Accordingly to the present invention, the cathode materials showed much better electrochemical performance with high capacity and stability. The presence of Fe³⁺ and Al³⁺ helps to improve stability and it has been proved in the present invention as the stability of all the materials is excellent. The capacity retention of the material is high due to the increased concentration of Al³⁺ and Fe³⁺. This proves that Al³⁺ and Fe³⁺ plays a critical role in stability of the material.

In another embodiment of the present invention, the materials with more Ni composition show more capacity than the one which has less Ni ratio. This indicates that Ni plays a crucial role in the capacity enhancement of the cathode materials. It is observed that the material with more Ni content shows more capacity, and the cathode material with more Fe and Al composition shows stable cycle life as compared to the materials with less Fe and Al composition. It confirms that the Fe and Al can be efficient electrochemical stabilizers to enhance the cycle stability of the cathode materials.

In an embodiment, the present invention relates to Li-ion battery comprising of the cathode material of formula

LiMn_{2-x-y-z}NiₓFe_{y}Al_{z}O₄

wherein:
x is 0.8-0.5;
y is 0.1-0.25; and
z is 0.1-0.25.

In another embodiment of the present invention lithium ion battery comprising
[1] a positive electrode (cathode) consisting a lithium-based material (cathode material)
[2] a negative electrode (anode), made up of carbon, for example, of graphite (anode material).
[3] a separator [3]; and
[4] an electrolyte [4]

In another embodiment of the present invention, the Li-ion battery can be 4.8 V batteries.

### EXAMPLES

Following examples are given by way of illustration and therefore should not be construed to limit the scope of the invention.

### Example 1: Synthesis of LiMnNi_{0.8}Fe_{0.1}Al_{0.1}O₄

Cobalt-free multi-ion doped LiMn₂O₄ material was synthesized by a simple sol-gel method using a stoichiometric amount of Lithium acetate dihydrate (CH₃COOLi 2H₂O), Manganese(II) acetate tetrahydrate (CH₃COO)₂Mn4H₂O), Nickel(II) acetate tetrahydrate (CH₃COO)₂Ni4H₂O), Iron oxalate dihydrate (FeC₂O₄2H₂O), and Aluminum nitrate nonahydrate (Al(NO₃)₃9H₂O) with the addition of citric acid monohydrate (C₆H₈O₇H₂O) as a chelating agent. All the precursors were dissolved in deionized water and kept for stirring at 60° C. to get the viscous gel. The viscous gel was dried at 100° C. for 2 hours in the oven and ground to get the powder of LiMnNi_{0.8}Fe_{0.1}Al_{0.1}O₄. The precursor was heat-treated at 400° C. for 4 hours to get the intermediate compound. The powder was further ground and calcined at 750° C. for 10 hours in air and cooled to room temperature, then ground into a fine powder of LiMnNi_{0.8}Fe_{0.1}Al_{0.1}O₄ (termed as (MNFA811)).

### Examples 2 to 5

The following catalyst systems of examples 2 to 5 were prepared by following the above experimental procedure with minor non-critical variations.

### Example 2

LiMnNi_{0.7}Fe_{0.1}Al_{0.2}O₄ termed as (MNFA712)

### Example 3

LiMnNi_{0.7}Fe_{0.2}Al_{0.1}O₄ termed as (MNFA721)

### Example 4

LiMnNi_{0.6}Fe_{0.2}Al_{0.2}O₄ termed as (MNFA622)

### Example 5

LiMnNi_{0.5}Fe_{0.25}Al_{0.25}O₄ termed as (MNFA52525)

### Electrochemical Studies

The electrical and electrochemical studies were performed by constructing CR-2032 coin cells in an argon atmosphere. The as-prepared powder (80 wt. %), super C-65 (10 wt. %), and polyvinylidene fluoride (10 wt. %) were mixed with few drops of N-methylpyrrolidone solvent to get a homogeneous mixture. This mixture was coated on Al-foil and dried at 80° C. in a vacuum oven and cut into circular discs of 14 mm. Li-foil was used as both reference and negative electrode. Celgard® 2325 Trilayer Microporous Membrane was used as a separator, and 1 M LiPF6 in ethylene carbonate-dimethyl carbonate-ethyl methyl carbonate (EC/DMC/EMC 1:1:1) solution was used as electrolyte.

Cyclic voltammetry (CV) studies were carried out at a scan rate of 0.1 mVs⁻¹ between voltage window of 3.50 V-4.99 V. As shown in FIG. 8, three pairs of redox peaks are observed at ˜4.08/4.03 V, ˜4.72/4.63 V, and ˜4.81/4.73 V, indicating three-step intercalation/deintercalation of Li⁺ during oxidation/reduction reaction. The first weak redox peak observed at 4.08/4.03 V corresponded to Mn⁴⁺/Mn³⁺ redox couple. This feeble peak is due to most Mn being in Mn⁴⁺ state, indicating the minimized content of Mn³⁺ in the material, which minimizes the John-Teller distortion. The second and third high intense redox peaks observed at 4.72/4.63 V and 4.81/4.73 V respectively corresponded to Ni²⁺/Ni⁴⁺, which indicates the predominant electrochemical activity of Ni in the active material.

The galvanostatic charge/discharge studies were performed between 3.5 to 5V at a constant current density of 1C over 1000 cycles, as shown in FIG. 10b. It can be seen that the initial discharge capacities are 142.9 mAhg⁻¹ (MNFA811), 148.7 mAhg⁻¹ (MNFA712), 131.2 mAhg⁻¹ (MNFA721), 126.4 mAhg⁻¹ (MNFA622), 101.2 mAhg⁻¹ (MNFA62525) while at the end of 1000 cycles the discharge capacities were decreased to for 120.0 mAhg⁻¹ (400 cycles, MNFA811) 118.3 mAhg⁻¹ (MNFA712), 108.7 mAhg⁻¹ (MNFA721), 112.4 mAhg⁻¹ (MNFA622), 81.5 mAhg⁻¹ (MNFA62525) with almost 100% coulombic efficiency. All the materials showed an extraordinary capacity retention of 83.9% (after 400 cycles, MNFA811), 79.5% (MNFA712), 82.8% (MNFA721), 88.9% (MNFA622), and 80.5% (MNFA52525) after 1000 cycles at 1C rate. All the materials of the present invention showed higher and better electrochemical performance with great stability.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The modified composite cathode material of the present invention is cobalt free.
The modified composite cathode material of the present invention is economic and environmentally friendly.
The modified composite cathode material of the present invention increases the capacity of the material with longer cyclability and excellent stability.
The modified cathode material of the present invention shows a very good cycling stability with almost 80% capacity retention even after 1000 cycles.
The coulombic efficiency of the cathode material of the present invention is constant even after 1000 cycles (99.2%).
The modified composite cathode material of the present invention can be used for 4.8 V applications.

1. An electrode material, comprising an electrode material of formula:
LiMn_{2-x-y-z}NiₓFe_{y}Al_{z}O₄
wherein:
x ranges from about 0.8 to about 0.5;
y ranges from about 0.1 to about 0.25; and
z ranges from about 0.1 to about 0.25.

2. The electrode material as claimed in claim 1, wherein the electrode material is a cathode material.

3. The electrode material as claimed in claim 1, wherein the electrode material is cobalt free.

4. The electrode material as claimed in claim 1, wherein x+y+z is 1.

5. The electrode material as claimed in claim 1, wherein x is 0.8, y is 0.1 or 0.2, and z is 0.1 or 0.2.

6. The electrode material as claimed in claim 1,
wherein:
x is 0.7;
y is 0.1; and
z is 0.2.

7. The electrode material as claimed in claim 1, wherein the material is selected from LiMnNi_{0.8}Fe_{0.1}Al_{0.1}O₄, LiMnNi_{0.7}Fe_{0.1}Al_{0.2}O₄, LiMnNi_{0.7}Fe_{0.2}Al_{0.1}O₄, LiMnNi_{0.6}Fe_{0.2}Al_{0.2}O₄ and LiMnNi_{0.5}Fe_{0.25}Al_{0.25}O₄.

8. The electrode material as claimed in claim 1, wherein capacity retention of the material is 83.9% after 400 cycles at 1C rate, and in a range of 79.5%-88.9% after 1000 cycles at 1C rate.

9. The electrode material as claimed in claim 3, wherein the cobalt free material comprises doped LiMn₂O₄, and wherein the dopants comprise Ni:Fe:Al present at a ratio ranging from about 0.8 to about 0.5:about 0.1 to about 0.25:about 0.1 to about 0.25.

10. A lithium ion battery, comprising:
i. a positive electrode consisting of a lithium-based material;
ii. a negative electrode comprising graphite;
iii. a separator; and
iv. an electrolyte.
